(19) United States
(12) Patent Application Publication
(10) Pub. No.: US 2009/0056413 A1
(43) Pub. Date: Mar. 5, 2009

(54) Method And System For Predicting Gas Turbine Emissions Utilizing Meteorological Data

(75) Inventors: Kotesh Rao, Pearland, TX (US); Vinay Jammu, Bangalore (IN); Abhinna Chandra Biswal, Bangalore (IN)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/850,167

(22) Filed: Sep. 5, 2007

(51) Int. Cl. G01N 7/00

(52) U.S. Cl. 73/23.31

(57) ABSTRACT

A method and system for determining gas turbine emissions utilizing meteorological data is provided. The method and system may include at least one emissions prediction system. The method and system may also predict at least one meteorological condition. The method and system may also determine an emissions allowance.

### BACKGROUND OF THE INVENTION

The present invention relates to turbomachine emissions; and more particularly to a method and system for automatically predicting gas turbine emissions utilizing meteorological data.

The emissions of a turbomachine, such as a gas turbine, are typically a function of various operating parameters and site weather conditions (temperature, pressure and humidity). Therefore, accurately predicting gas turbine emissions is challenging due to the variations in the operating parameters causing changes in such as compressor discharge pressure, compressor discharge temperature, firing temperature, and output (load) that cause variations in emissions. Site ambient conditions, such temperature, atmospheric pressure and humility, and the like; also impact emissions. For example, NOx emissions are generally reduced, by increases in humidity and ambient temperature. Relatively low levels of Nox emissions may cause the gas turbine to operate near the lean-blowout (LBO) margin of the combustion system, which may cause a trip. To avoid the trip, the gas turbine operator typically changes operational settings by “tuning” the combustion system.

Gas turbines are generally tuned after a major upgrade; periodically on a seasonal basis; when there is a potential or an actual emissions issue; or when combustion dynamics exceed a limit.

There are a few problems with the currently known systems. The currently known systems may not, in real-time accurately predict the emissions of a gas turbine. The currently known systems may not provide a quantitative approach to predicting emissions utilizing meteorological data and thus allowing for the proactive tuning of the gas turbine to avoid LBO related trips. The currently known systems may not provide for automatically predicting the allowable emissions margin of a gas turbine for use with an emission credit trading system, or the like.

For the foregoing reasons, there is a need for a method and system for automatically predicting the future emissions of a gas turbine. The method should utilize meteorological data. The method should provide a quantitative approach to predicting future emissions allowing for the proactive tuning of the gas turbine to avoid LBO related trips. The method should also allow for integration with an emission credit trading system, or the like.

### BRIEF DESCRIPTION OF THE INVENTION

In accordance with an embodiment of the present invention, a method of determining gas turbine emissions utilizing meteorological data, the method comprising: providing at least one emissions prediction system, wherein the at least one emissions prediction system predicts a generated emissions level of at least one gas turbine; receiving a plurality of operating data corresponding to the at least one gas turbine; receiving a plurality of meteorological data; and generating an emissions output notification based on the plurality of meteorological data; the notification comprising the generated emissions level.

In accordance with an alternate embodiment of the present invention, a method of determining gas turbine emissions utilizing meteorological data, the method comprising: providing at least one emissions prediction system, wherein the at least one emissions prediction system predicts a generated emissions level of at least one gas turbine; receiving a plurality of operating data corresponding to the at least one gas turbine, wherein the plurality of operating data comprises at least one of: combustion dynamics data; emissions data; at least one control valve position data; compressor temperature discharge data; and compressor pressure discharge data; receiving a plurality of meteorological data; generating an emissions output notification comprising the generated emissions level; determining whether a combustion tuning of the at least one gas turbine is desirable based on the notification comprising the generated emissions level; and generating a combustion tuning request when the combustion tuning of the at least one gas turbine is desirable.

In accordance with another alternate embodiment, a system for determining gas turbine emissions utilizing meteorological data, the system comprising: at least one emissions prediction system; means for receiving a plurality of operating data corresponding to the at least one gas turbine; means for receiving a plurality of meteorological data; and means for generating an emissions output notification based on the plurality of meteorological data.

### BRIEF DESCRIPTION OF THE DRAWINGS

FIG. 1 is a schematic illustrating the environment in which an embodiment of the present invention operates.

FIG. 2 is a flowchart illustrating an example of a method of predicting the emissions of a gas turbine in accordance with an embodiment of the present invention.

FIG. 3 is a flowchart illustrating an example of a method of determining meteorological data in accordance with an embodiment of the present invention.

FIG. 4 is a flowchart illustrating an example of a method of determining an emission allowance in accordance with an embodiment of the present invention.

FIG. 5 is a block diagram of an exemplary system for predicting the emissions of a gas turbine in accordance with an embodiment of the present invention.

### DETAILED DESCRIPTION OF THE INVENTION

As will be appreciated, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The following detailed description of preferred embodiments refers to the accompanying drawings, which illustrate specific embodiments of the invention. Other embodiments having different structures and operations do not depart from the scope of the present invention.

An embodiment of the present invention takes the form of an application and process that utilizes meteorological data to predict the emissions from at least one gas turbine. The present invention may receive a plurality of operating data from the at least one gas turbine. The plurality of operating data may include combustion dynamics data; emissions data; at least one control valve position data; compressor temperature discharge data; and compressor pressure discharge data. An embodiment of the present invention may utilize the operating data to predict the future emissions of the at least one gas turbine.

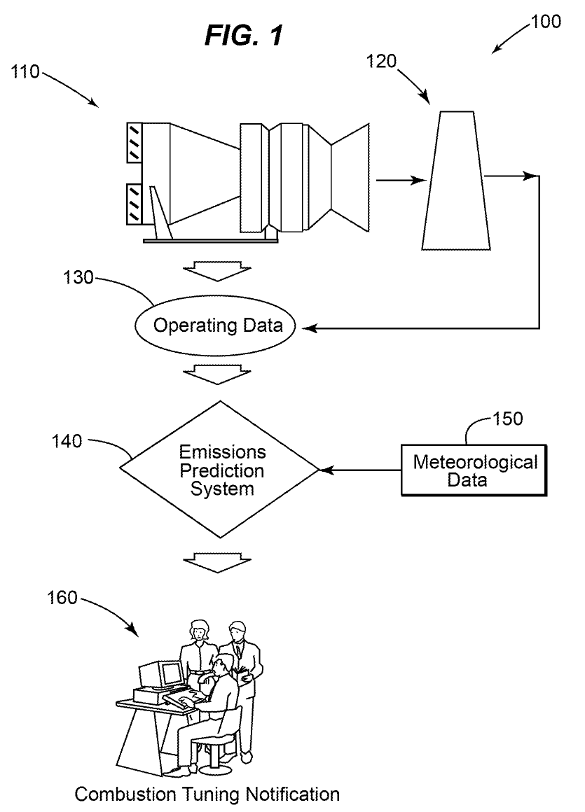

Referring now to the Figures, where the various numbers represent like elements throughout the several views, FIG. 1 is a schematic illustrating the environment in which an embodiment of the present invention operates. FIG. 1 illustrates a power plant site 100 comprising at least one gas turbine 110; an exhaust stack 120; a plurality of operating data 130; an emissions prediction system 140; meteorological data system 150; and a combustion tuning notification generator 160.

The power plant site 100 may comprise at least one control system or the like (not illustrated) which may receive the plurality of operating data 130 from the at least one gas turbine 120. The exhaust stack 120 may include a continuous emission monitoring system (CEMS), or the like, which typically determines the current emissions emitted by the gas turbine 110. The CEMS may allow for the current emissions data to be included with the plurality of operating data 130. The plurality of operating data 130 may be transmitted to at least one emissions prediction system 140.

The meteorological data system 150 may provide a plurality of meteorological data 150 on the power plant site 100. The plurality of meteorological data 150 may include, but not limited to: ambient temperature; barometric pressure; humidity; and combinations thereof. The meteorological data system 150 may transmit the plurality of meteorological data 150 to the emissions prediction system 140.

The emissions prediction system 140 may have the form of a continuous diagnostic engine (not illustrated), or the like. The emissions prediction system 140 may apply at least one math engine, or the like, to predict the future emissions of the gas turbine 110.

The combustion tuning notification generator 160 may automatically generate a notification when the gas turbine 110 requires combustion tuning. The present invention may also allow for the notification to be automatically sent to the operator of the power plant site 100. The present invention may allow for the notification to be automatically sent to a third-party support system. For example, but not limiting of, the third-party support system may be contacted if present invention determines that the emissions prediction system 140 indicates a potential emissions issue.

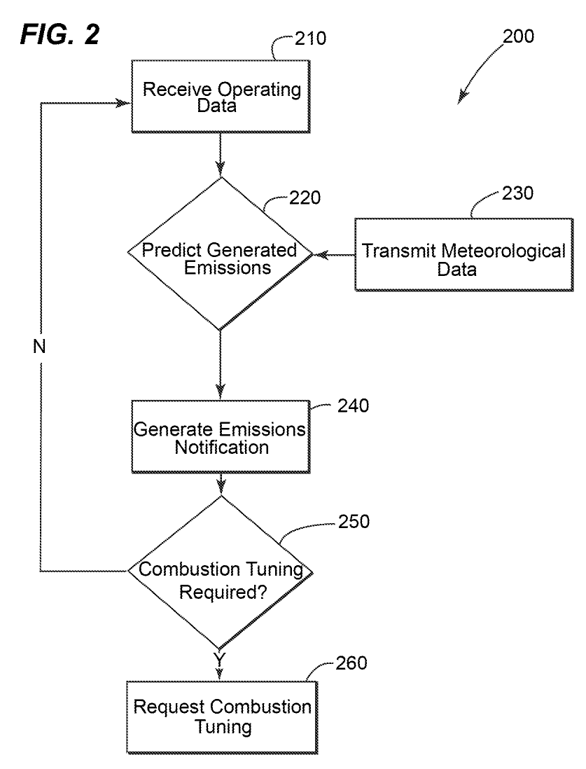

Referring now to FIG. 2, which is a flowchart illustrating an example of a method 200 of predicting the emissions of a gas turbine in accordance with an embodiment of the present invention. In step 210, the method 200 may receive a plurality of operating data 130 from at least one power plant machine 110 (not illustrated in FIG. 2). An embodiment of the present invention may allow for receiving the plurality of operating data 130 from multiple gas turbines 110. For example, but not limiting of, the method 200 in step 210 may receive the plurality of operating data 130 from a first gas turbine; a second gas turbine; and a third gas turbine; located on the power plant site 100.

The plurality of operating data 130 may be received at different sampling rates, or the like, such as, but not limiting of the invention, one data point per second (1/sec) or one data point per thirty seconds ( 1/30 sec). Generally, during the operation of a power plant machine 110, certain operating data points may be used for monitoring purposes, while other operating data points may be used for controlling or other purposes that require a higher sampling rate. Here, to conserve the storage space, which may be used to store the operating data 130, the operating data, points used for monitoring may be received at a slower sampling rate, such as 1/30 sec. Furthermore, the operating data points used for controlling may be received at a higher sampling rate, such as 1/sec. For example, but not limiting of, an operating data point used for monitoring the ambient temperature may be received at a slower sampling rate, such as 1/30 sec; and an operating data point used for controlling the position of at least one control valve may be received at a higher sampling rate, such as 1/sec.

In step 220, the method 200, may predict the future generated emissions of the gas turbine 110. The plurality of operating data 130 received in step 210 may be incorporated into at least one algorithm or the like. As illustrated, step 220 may also receive a plurality of meteorological data 150 from step 230.

An embodiment of the present invention may utilize at least one continuous diagnostic engine (not illustrated in FIG. 2) to predict the future emissions. Generally, the continuous diagnostic engine may, in real-time, utilize a portion of the plurality of operating data 130 and a portion of the plurality of meteorological data, to perform at least one calculation to predict the future emissions. The portions of the aforementioned data may include analog and digital data points. For example, but not limiting of, the continuous diagnostic engine may use data representing: combustion dynamics data; emissions data; at least one control valve position data; compressor temperature discharge data; compressor pressure discharge data; atmospheric pressure; ambient temperature; and combinations thereof.

The continuous diagnostic engine may include at least one algorithm incorporating a plurality of equations, or the like, which may predict future emissions from the gas turbine 110. For example, but not limiting of, the plurality of equations may include: a real-time model for predicting NOₓ emissions as shown:

$$NOx = {NOx}_{Nominal} * {e}^{Δ {T}_{Flame}} * {e}^{- Δ SH} * {( \frac{CPD}{{CPD}_{iso}} )}^{0.5} * Q$$

Where:
NOx_{Nominal}—may be considered the NOₓ level under nominal operating conditions as defined or accepted by the user;
ΔT_{Flame}—may be considered the difference between an actual firing temperature and a reference firing temperature;
ΔSH—may be considered the difference between the current specific humidity and the specific humidity at ISO conditions;
CPD—may be considered the compressor pressure discharge;
CPDᵢₛₒ—may be considered the compressor pressure discharge at ISO conditions; and
Q—may be considered the fuel flow rate.

An embodiment of the present invention may also allow a user to customize the continuous diagnostic engine to account for site specific and/or gas turbine 110 specific conditions. For example, but not limiting of, the continuous diagnostic engine may include at least one file having site specific constants and a separate file containing gas turbine 110 specific constants; both of which may be utilized by the algorithm, or the like, of the continuous diagnostic engine.

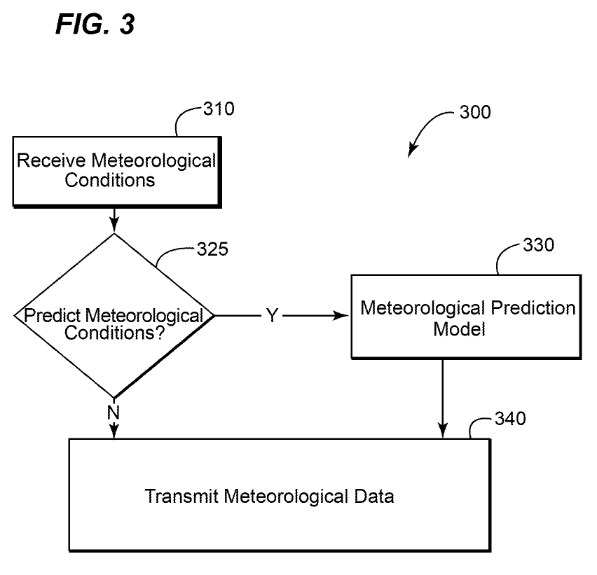

Returning to FIG. 2, the method 200, in step 230, may transmit a plurality of meteorological data 150 to the at least one continuous diagnostic engine, or the like, previously discussed in step 220. The plurality of meteorological data 150 may include: ambient temperature; barometric pressure; humidity; and combinations thereof. An embodiment of the present invention may receive the plurality of meteorological data 150 from devices that may determine the weather conditions around the gas turbine 110. An embodiment of the present invention may provide a method for predicting the meteorological data, as discussed below in FIG. 3.

In step 240, the method 200, may generate an emissions notification indicating the predicted generated emissions determined in step 220. The notification may be automatically generated and automatically transmitted to the operator of the gas turbine 110. In an alternate embodiment of the present invention, the emissions notification may be automatically transmitted to a support system, such as but not limiting of, a third-party service of which the operator of the gas turbine 110 subscribes. For example, but not limiting of, the support system may be provided by the original equipment manufacturer (OEM), or the like.

In step 250, the method 200 may determine whether combustion tuning of the gas turbine 110 may be desirable. Typically, a power plant site 100 having a gas turbine 110 is required to limit the level of emissions, such as but not limiting of, NO, and CO₂. Operators of gas turbines 110 typically prefer to have an emissions operating margin (hereinafter margin), or the like. The margin may be considered a tolerance around the emissions limit. For example, but not limiting of, an emissions limit of 7 ppm of NOₓ may have a margin of +/−1.5 ppm. Here, if the current NOₓ emissions are outside of the margin, combustion tuning may be desirable.

Furthermore, in step 250, the value of the emissions predicted in step 220 may be compared to a corresponding emissions limit with margin (if applicable). If combustion tuning is desirable, then the method 200 may proceed to step 260; otherwise the method 200 may revert to step 210.

In step 260, the method 200 may request combustion tuning. Here, the request may be a notification alerting the operator of the gas turbine 110 of a possible need for tuning. In an alternate embodiment of the present invention, the notification may be sent to a support system, such as but not limiting of, a third-party service of which the operator of the gas turbine 110 subscribes, as previously discussed.

Referring now to FIG. 3, which is a flowchart illustrating an example of a method 300 of determining meteorological data in accordance with an embodiment of the present invention. In step 310, the method 200 may receive a plurality of ineteorological data 150 from a plurality of devices that may determine the weather conditions around the gas turbine 110. The plurality of meteorological data 150 may include: ambient temperature; barometric pressure; humidity; and combinations thereof. For example, but not limiting of, the gas turbine 110 may have a humidity sensor, which may determine the relative and/or specific humidity to the method 300.

In step 320, the method 300 may determine whether to predict meteorological conditions. As discussed, the weather conditions may impact the emissions level of an operating gas turbine 110. Weather conditions may cause the gas turbine 110 to operate out of emissions compliance; or may cause a LBO condition, as previously described. A user may desire to predict the upcoming weather conditions for use in determining future the emissions level of the operating gas turbine 110. If a user desires to predict the meteorological conditions; then the method 300 may proceed to step 330; otherwise the method 300 may proceed to step 340.

In step 330, the method 300 may utilize the meteorological prediction model to determine the future weather conditions. Here, the model may access at least one third-party weather service, or the like. The model may interpolate the data from the weather service along with data received from the plurality of devices, discussed in step 310, to predict the weather conditions near the gas turbine 110. For example, but not limiting of, the model may interpolate data received from The National Weather Service to predict the weather conditions near the gas turbine 110.

In step 340, the method 300 may transmit the meteorological to step 230 of the method 200, as discussed. Here, the meteorological data may derive from either step 310 or step 330, as described.

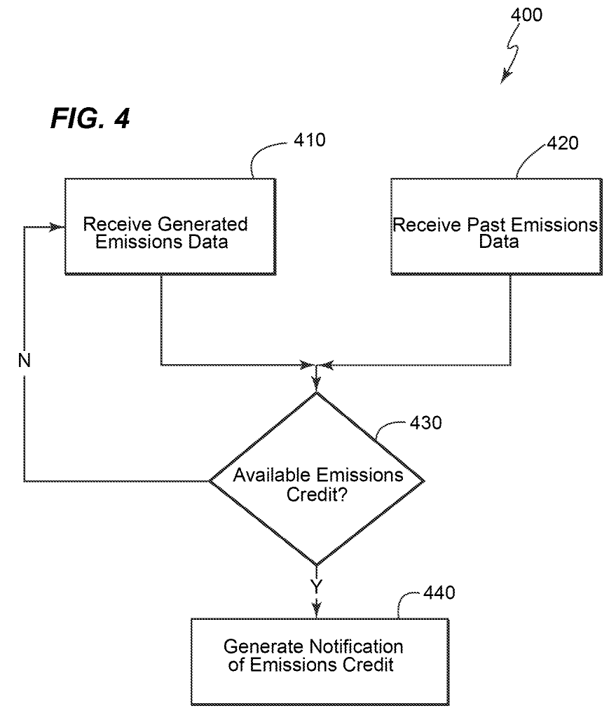

Referring now to FIG. 4, which is a flowchart illustrating an example of a method 400 of determining an emission allowance in accordance with an embodiment of the present invention.

Some power plant sites 100 may be allowed to transfer a portion of the allowable generated emissions, in the form of an emissions credit trading system, or the like. For example, but not limiting of, a power plant site 100 having gas turbines 110 with two different combustion systems may be limited to total generation allowance of 25 ppm NOₓ emissions. Here, the operator of the power plant site 100 is typically allowed to apportion the NOₓ allowance among the two gas turbines 10 provided that the total generated emissions does not exceed 25 ppm. Another example, but not limiting of, is when separate power plant sites 100 enter agreements, or the like, to trade or sell used portions of emissions credits. Hence, operators of power plant sites 110 may desire a system for determining the emissions credit of the gas turbine 110.

In step 410, the method 400 may receive the current generated emissions data determined in steps 220 and 240 in FIG. 2, as previously discussed.

In step 420, the method 400 may receive past emissions data from previous gas turbine 110 operations.

In step 430, the method 400 may determine an emissions credit. Here, the method 400 may sum the currently emissions data and the past emissions data; and then compare the sum with an emissions limit. The emission limit may represent the maximum amount of emissions for the specific gas turbine 110 on the power plant site 100. If an emissions credit exists, then the method 400 may proceed to step 440; other the method 400 may revert to step 410.

In step 440, the method 400, may generate a notification of the emissions credit. The notification may be automatically transmitted to the operator of the power plant site 100. In an alternate embodiment of the present invention, the notification may also be transmitted to a third-party emissions credit trading system that the power plant site 100 partakes.

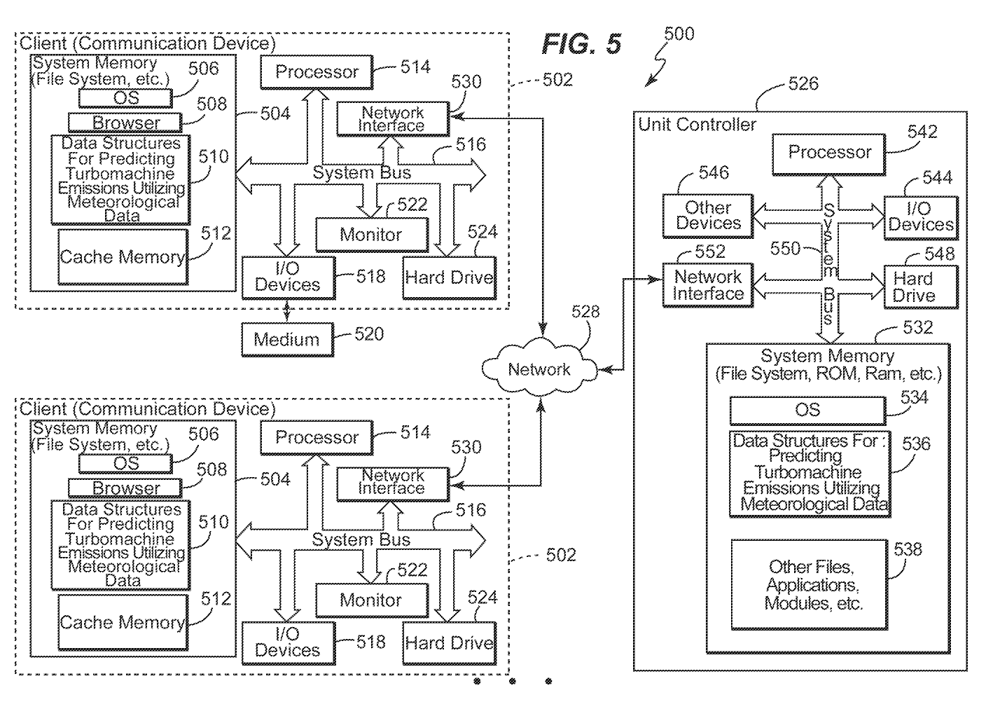

Referring now to FIG. 5, which is a step diagram of an exemplary system 500 for predicting the emissions of a gas turbine in accordance with an embodiment of the present invention. The elements of the methods 200, 300, and 400 may be embodied in and performed by the system 500. The system 500 may include one or more user or client communication devices 502 or similar systems or devices (two are illustrated in FIG. 5). Each communication device 502 may be for example, but not limited to, a computer system, a personal digital assistant, a cellular phone, or similar device capable of sending and receiving an electronic message.

The communication device 502 may include a system memory 504 or local file system. The system memory 504 may include for example, but is not limited to, a read only memory (ROM) and a random access memory (RAM). The ROM may include a basic input/output system (BIOS). The BIOS may contain basic routines that help to transfer information between elements or components of the communication device 502. The system memory 504 may contain an operating system 506 to control overall operation of the communication device 502. The system memory 504 may also include a browser 508 or web browser. The system memory 504 may also include data structures 510 or computer-executable code to predict the emissions that may be similar or include elements of the methods 200, 300, and 400 in FIGS. 2, 3, and 4, respectively.

The system memory 504 may further include a template cache memory 512, which may be used in conjunction with the methods 200, 300, and 400 in FIGS. 2, 3, and 4, respectively to predict the emissions.

The communication device 502 may also include a processor or processing unit 514 to control operations of the other components of the communication device 502. The operating system 506, browser 508, data structures 510 may be operable on the processor 514. The processor 514 may be coupled to the memory system 504 and other components of the communication device 502 by a system bus 516.

The communication device 502 may also include multiple input devices (I/O), output devices or combination input/output devices 518. Each input/output device 518 may be coupled to the system bus 516 by an input/output interface (not shown in FIG. 5). The input and output devices or combination I/O devices 518 permit a user to operate and interface with the communication device 502 and to control operation of the browser 508 and data structures 510 to access, operate and control the software to predict the emissions. The I/O devices 518 may include a keyboard and computer pointing device or the like to perform the operations discussed herein.

The I/O devices 518 may also include for example, but are not limited to, disk drives, optical, mechanical, magnetic, or infrared input/output devices, modems or the like. The I/O devices 518 may be used to access a medium 520. The medium 520 may contain, store, communicate, or transport computer-readable or computer-executable instructions or other information for use by or in connection with a system, such as the communication devices 502.

The communication device 502 may also include or be connected to other devices, such as a display or monitor 522. The monitor 522 may be used to permit the user to interface with the communication device 502.

The communication device 502 may also include a hard disk drive 524. The hard drive 524 may be coupled to the system bus 516 by a hard drive interface (not shown in FIG. 5). The hard drive 524 may also form part of the local file system or system memory 504. Programs, software, and data may be transferred and exchanged between the system memory 504 and the hard drive 524 for operation of the communication device 502.

The communication device 502 may communicate with a remote server 526 and may access other servers or other communication devices similar to communication device 502 via a network 528. The system bus 516 may be coupled to the network 528 by a network interface 530. The network interface 530 may be a modem, Ethernet card, router, gateway, or the like for coupling to the network 528. The coupling may be a wired or wireless connection. The network 528 may be the Internet, private network, an intranet, or the like.

The server 526 may also include a system memory 532 that may include a file system, ROM, RAM, and the like. The system memory 532 may include an operating system 534 similar to operating system 506 in communication devices 502. The system memory 532 may also include data structures 536 for predicting the emissions. The data structures 536 may include operations similar to those described with respect to the method 200 for predicting the emissions. The server system memory 532 may also include other files 538, applications, modules, and the like.

The server 526 may also include a processor 542 or a processing unit to control operation of other devices in the server 526. The server 526 may also include I/O device 544. The I/O devices 544 may be similar to I/O devices 518 of communication devices 502. The server 526 may further include other devices 546, such as a monitor or the like to provide an interface along with the I/O devices 544 to the server 526. The server 526 may also include a hard disk drive 548. A system bus 550 may connect the different components of the server 526. A network interface 552 may couple the server 526 to the network 528 via the system bus 550.

The flowcharts and step diagrams in the Figures illustrate the architecture, functionality, and operation of possible implementations of systems, methods, and computer program products according to various embodiments of the present invention. In this regard, each step in the flowchart or step diagrams may represent a module, segment, or portion of code, which comprises one or more executable instructions for implementing the specified logical function(s). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of determining gas turbine emissions utilizing meteorological data, the method comprising:
providing at least one emissions prediction system, wherein the at least one emissions prediction system predicts a generated emissions level of at least one gas turbine;
receiving a plurality of operating data corresponding to the at least one gas turbine;
receiving a plurality of meteorological data; and
generating an emissions output notification based on the plurality of meteorological data; the notification comprising the generated emissions level.

2. The method of claim 1, further comprising:
determining whether a combustion tuning of the at least one gas turbine is desirable based on the notification comprising the generated emissions level; and
generating a combustion tuning request when the combustion tuning of the at least one gas turbine is desirable.

3. The method of claim 1, wherein the step of receiving the plurality of meteorological data further comprises:
receiving at least one meteorological condition;
determining whether to predict at least one additional meteorological condition; and
transmitting the plurality of meteorological data.

4. The method of claim 3, wherein the step of determining whether to predict the at least one meteorological condition comprises utilizing at least one meteorological prediction model.

5. The method of claim 1, wherein the at least one emissions prediction system further comprises an emissions allowance method comprising:
receiving the generated emissions level;
determining an emissions credit; and
generating a notification of the emissions credit.

6. The method of claim 5, wherein the step of determining the emissions allowance comprises receiving past emissions data.

7. The method of claim 1, wherein the plurality of operating data comprises at least one of: combustion dynamics data; emissions data; at least one control valve position data; compressor temperature discharge data; and compressor pressure discharge data.

8. The method of claim 1, wherein the step of providing the at least one emissions prediction system further comprises integrating the emissions prediction system with at least one monitoring and diagnostics system.

9. The method of claim 1, wherein the step of providing the at least one emissions prediction system further comprises integrating the emissions prediction system with at least one emissions trading system.

10. A method of determining gas turbine emissions utilizing meteorological data, the method comprising:
providing at least one emissions prediction system, wherein the at least one emissions prediction system predicts a generated emissions level of at least one gas turbine;
receiving a plurality of operating data corresponding to the at least one gas turbine, wherein the plurality of operating data comprises at least one of: combustion dynamics data; emissions data; at least one control valve position data; compressor temperature discharge data; and compressor pressure discharge data;
receiving a plurality of meteorological data;
generating an emissions output notification comprising the generated emissions level;
determining whether a combustion tuning of the at least one gas turbine is desirable based on the notification comprising the generated emissions level; and
generating a combustion tuning request when the combustion tuning of the at least one gas turbine is desirable.

11. The method of claim 10, wherein the step of receiving the plurality of meteorological data comprises:
receiving at least one meteorological condition;
determining whether to predict at least one additional meteorological condition; and
transmitting the plurality of meteorological data.

12. The method of claim 11, wherein the step of determining whether to predict the at least one meteorological condition comprises utilizing at least one meteorological prediction model.

13. The method of claim 11, wherein the emissions prediction system further comprises an emissions allowance method comprising:
receiving the generated emissions level;
determining an emissions credit; and
generating a notification of the emissions credit.

14. The method of claim 13, wherein the step of determining the emissions allowance comprises receiving past emissions data.

15. The method of claim 10, wherein the step of providing the at least one emissions prediction system further comprises integrating the emissions prediction system with at least one monitoring and diagnostics system.

16. The method of claim 10, wherein the step of providing the at least one emissions prediction system further comprises integrating the emissions prediction system with at least one emissions credit trading system.

17. A system for determining gas turbine emissions utilizing meteorological data, the system comprising:
at least one emissions prediction system;
means for receiving a plurality of operating data corresponding to the at least one gas turbine;
means for receiving a plurality of meteorological data; and
means for generating an emissions output notification based on the plurality of meteorological data.

18. The system of claim 17, wherein the step of receiving the plurality of meteorological data comprises:
means for receiving at least one meteorological condition;
means for determining whether to predict at least one meteorological condition; and
means for transmitting the plurality of meteorological data.

19. The system of claim 17, wherein the emissions prediction system comprises an emissions allowance system comprising:
means for receiving the generated emissions level;
means for determining an emissions credit comprising:
means for receiving past emissions data; and
means for comparing the past emissions data with at least one allowable emissions limit; and
means for generating a notification of the emissions credit.

20. The system of claim 17, further comprising:
means for determining whether a combustion tuning of the at least one gas turbine is desirable based on the notification comprising the generated emissions level; and
means for generating a combustion tuning request when the combustion tuning of the at least one gas turbine is desirable.
